(19) United States
(12) Patent Application Publication
(10) Pub. No.: US 2008/0308540 A1
(43) Pub. Date: Dec. 18, 2008

(54) Engine driven welding machine

(76) Inventors: Toru Hiroi, Sakado-shi (JP); Kentaro Kawabata, Sayama-shi (JP)

Correspondence Address: JACOBSON HOLMAN PLLC, 400 SEVENTH STREET N.W., SUITE 600, WASHINGTON, DC, 20004, US

(21) Appl. No.: 11/898,687

(22) Filed: Sep. 14, 2007

(30) Foreign Application Priority Data
Jun. 15, 2007 (JP) 2007-159139

(51) Int. Cl. B23K 9/10

(52) U.S. Cl. 219/130.21; 219/130.4; 219/133

(57) ABSTRACT

An engine driven welding machine which is favorable in operability and has high reliability and reliably performs idle stop and restart is provided. An engine driven welding machine in which a welding generator is driven by an engine, and the aforesaid engine performs an idle operation when a welding operation is stopped is characterized by including an engine stop signal forming circuit IT which forms a stop signal for stopping an operation of the aforesaid engine when time of the aforesaid idle operation exceeds a predetermined time, a direct-current power supply PS connected to an output terminal of the aforesaid welding machine, voltage detecting means VS which detects a voltage change of the aforesaid output terminal, a restart detecting circuit RS which forms a restart signal for restarting the aforesaid engine when the detected voltage by the aforesaid voltage detecting means shows a predetermined change mode for starting the welding operation, and an engine control circuit EC which stops the aforesaid engine in response to the aforesaid stop signal, and restarts the aforesaid engine in response to the aforesaid restart signal.

### CROSS REFERENCE TO RELATED APPLICATIONS

This application is based upon and claims the benefit of priority from the prior Japanese Patent Application No. 2007-159139, filed on Jun. 15, 2007, the entire contents of which are incorporated herein by reference.

### BACKGROUND OF THE INVENTION

1. Field of the Invention

The present invention relates to an engine driven welding machine, and particularly to a technique of reducing the amount of time that an engine wastefully runs at idle as much as possible and increasing reliability of restart of the engine.

2. Related Art

In an engine driven welding machine, in order to reduce fuel consumption and noise of an engine, the engine shifts to an idle operation from a standard operation every time a welding operation is stopped, and the engine is returned to the standard operation from the idle operation every time the operation is started. When the welding operation is stopped for a long time, an operator himself stops the engine.

However, the situation is different when a welding operation is performed at high elevations of a high-rise building and the like, and when the welding machine main body is placed on the ground and power is supplied by running a welding cable to an operation site. In such a case, when the welding operation is stopped for some long time, in order to stop the engine, the operator descends to the ground and performs a stop operation, and this is troublesome and not efficient.

Thus, there is proposed a method for performing a remote control by transmitting a remote control high frequency signal by superimposing it on a welding cable (see Patent Document 1). This forms an operation signal by a touch sensor in which a noise filter for signal extraction is incorporated or a similar welding holder, and can stop the engine by sending the operation signal to the welding machine main body by an operation of an operator.

[Patent Document 1] Japanese Patent Laid-Open No. 4-162964

However, there is the problem in the operation site in the respect that the touch sensor may be lost, and since the welding holder with the noise filter incorporated therein is not widely used, the problem is in unsolved.

### SUMMARY OF THE INVENTION

The present invention is made in view of the above described point, and has an object to provide an engine driven welding machine which is favorable in operability, has high reliability and reliably performs idle stop and restart.

In order to attain the above-described object, the present invention provides an engine driven welding machine in which a welding generator is driven by an engine, and the aforesaid engine performs an idle operation when a welding operation is stopped, characterized by including an engine stop signal forming circuit which forms a stop signal for stopping an operation of the aforesaid engine when a time of the aforesaid idle operation exceeds a predetermined time, a direct-current power supply connected to an output terminal of the aforesaid welding machine, voltage detecting means which detects a voltage change of the aforesaid output terminal, a restart detecting circuit which forms a restart signal for restarting the aforesaid engine when the detected voltage by the aforesaid voltage detecting means shows a predetermined change mode for starting the welding operation, and an engine control circuit which stops the aforesaid engine in response to the aforesaid stop signal, and restarts the aforesaid engine in response to the aforesaid restart signal.

As described above, in the present invention, the operation of the engine is stopped based on the engine stop signal, and the engine is restarted by surely detecting the voltage change showing the start of a welding operation. Therefore, stopping the engine when it is not required and restarting the engine when it is required can be reliably carried out in the present invention.

### BRIEF DESCRIPTION OF THE DRAWINGS

FIG. 1 is a circuit diagram showing a configuration of one embodiment of the present invention;

FIG. 2 is a timing chart showing a principle of formation of a restart signal in the embodiment in FIG. 1;

FIG. 3 is a flow chart for explaining an operation of the embodiment shown in FIG. 1; and

FIG. 4 is a flowchart showing an operation of restart in the flowchart shown in FIG. 3 in detail.

### DETAILED DESCRIPTION OF THE INVENTION

Hereinafter, embodiments of the present invention will be described with reference to the attached drawings.

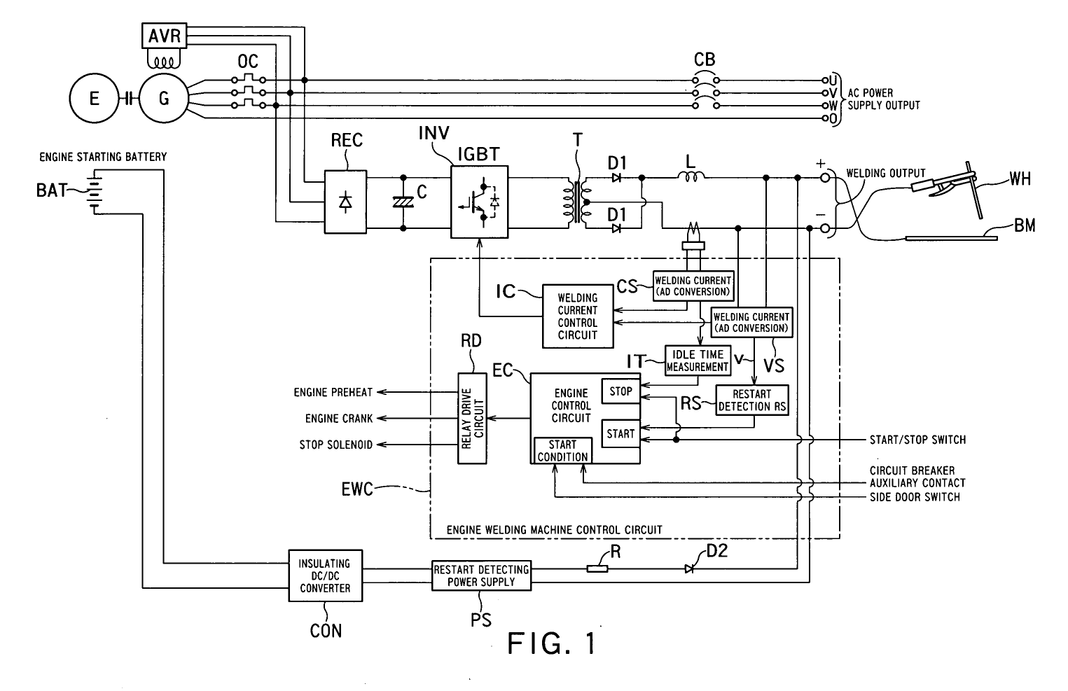

FIG. 1 is a circuit diagram showing a configuration of one embodiment of the present invention.

### Embodiment 1

FIG. 1 is a block diagram showing a circuit configuration of an embodiment 1 of the present invention. The embodiment 1 is applied to a welding machine which supplies an alternating-current power supply output and welding output by driving a welding generator G by an engine E as shown in FIG. 1.

The welding generator G takes out the output controlled by an automatic voltage regulator AVR via an over current relay OC and divides it into two, and supplies one to output terminals U, V, W and O through a circuit breaker CB, and supplies the other one to output terminals + and − by subjecting it to DC-AC conversion and AC-DC conversion after a rectifying circuit REC and welding current control.

The rectified output of the rectifying circuit REC is given to an inverter INV through a capacitor C and subjected to AC conversion, then is given to the output terminals + and − as direct-current output via a high-frequency transformer T, rectifiers D1 and D1 and a direct-current reactor L, and is supplied to a welding holder WH and a base material BM.

The voltage and current given to the output terminals + and − are detected by a welding voltage detector VS and a welding current detector CS and used for controlling the inverter INV via a welding current control circuit IC, and are used for controlling the engine E via a restart detecting circuit RS, an idle time measuring circuit IT, an engine control circuit EC and a relay drive circuit RD.

Specifically, a detected voltage “v” of the welding voltage detector VS is given to the welding current control circuit IC on one hand, and is given to a start port of the engine control circuit EC via the restart detecting circuit RS on the other hand.

The detected current of the welding current detector CS is given to the welding current control circuit IC on one hand, and is given to a stop port of the engine control circuit EC via the idle time measuring circuit IT on the other hand.

The welding current control circuit IC controls the inverter INV based on the detected voltage of the welding voltage detector VS and the detected current of the welding current detector CS, and controls the welding current to be supplied to the output terminals + and −.

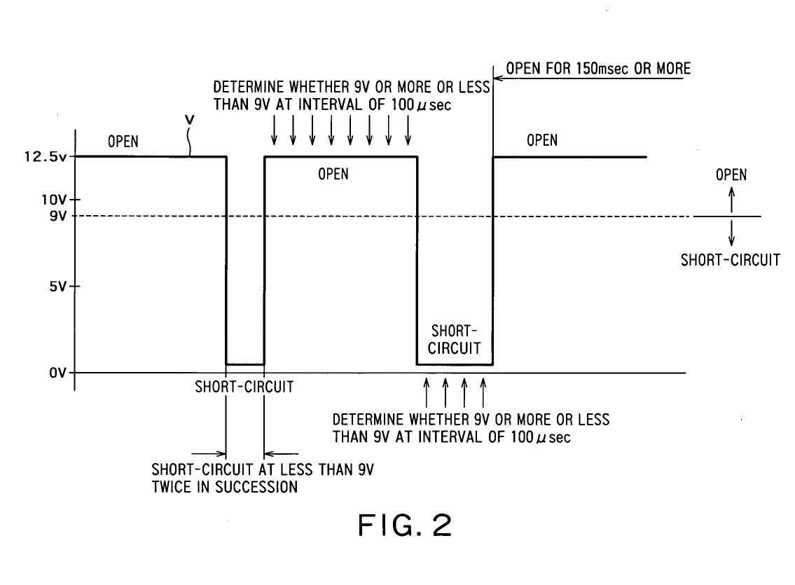

The restart detecting circuit RS has a function of detecting the welding start operation of an operator using a welding rod WH given via the welding voltage detector VS to form a detection signal for restarting the engine. The operation content is to always apply direct-current voltage between the output terminals + and −, take out the voltage change formed by the operator causing the welding rod WH to contact the base material BM to form the restart detection signal and give it to the engine control circuit EC, as will be described later by using FIG. 2.

As the direct-current power supply for restart detection which always applies direct-current voltage between the output terminals + and −, a battery BAT, an insulating DC/DC converter CON, a restart detecting power supply PS, a resistor R and a diode D2 are provided.

In order not to perform an unnecessary idle operation, the idle time measuring circuit IT gives a stop signal to the stop port of the engine control circuit EC to stop the engine E when the idle time becomes a predetermined length.

In addition to the signals from the idle time measuring circuit IT and the restart detecting circuit RS, signals from the starting/stopping switch are given to the start port or the stop port, and the engine control circuit EC operates engine preheat, an engine crank and a stopping solenoid of the engine E via the relay drive circuit RD. Further, on the occasion of performing this operation, the engine control circuit EC refers to each open/closed state of a circuit breaker auxiliary contact and a side door switch provided at a welding machine casing.

FIG. 2 is a voltage timing chart showing a detecting operation of the restart detecting circuit RS in FIG. 1. The detecting operation is to catch a predetermined change of a direct-current voltage “v” which is always applied between the output terminals + and −.

A direct-current voltage is applied to the output terminals + and − from the restart detecting power supply PS not only during the welding operation but also during the idle time of the engine E. Accordingly, unless the welding rod WH and the base material BM are short-circuited, the voltage between the output terminals + and − is applied to the restart detector RS via the welding voltage detector VS.

Reducing the voltage by short-circuiting the output terminals + and − by causing the welding rod WH to contact the base material BM is made a sign for restart, and the engine E is restarted by catching the sign. The sign is set in advance as the contact operation of causing the welding rod WH to contact the base material BM twice at a predetermined interval like “tap, tap”, or the contact operation of causing the welding rod WH to contact the base material BM three times like “tap, tap, tap”.

As a result, unexpected restart is not caused by an unintentional voltage change due to incomplete control of the welding holder, and the engine can be restarted only when the voltage change mode showing the start of the welding operation is reliably detected. The engine can be restarted by only the contact operation of the welding rod, and therefore, extremely favorable operability is provided.

“Open” in FIG. 2 shows the state in which the welding rod WH does not contact the base material BM, whereas “short-circuit” shows the state in which it contacts the base material BM. As for the voltage between the output terminals + and −, voltage of 12.5 V is applied when the terminals are open, and the voltage reduces close to 0 V in the short-circuit state.

The restart detecting circuit VS continuously monitors the voltage every 100 μs, for example, and once catching the short-circuit state, it monitors the time when the next short-circuit state occurs. “Short-circuit for restart” means the short-circuit, in which the state at less than 9 V successively occurs twice or more at the intervals of 100 μs, occurs once more at the interval of 150 ms or more.

Accordingly, the state where the voltage becomes less than 9 V successively twice or more due to noise or the like is not regarded as “short-circuit for restart”. Specifically, when the duration of the first short-circuit is the length of 100 microseconds or more, the short-circuit state of the same length occurs once again with “open” for 150 ms or more occurring between the first short-circuit and the second short-circuit, and the “open” of 150 ms or more occurs again next, the state is regarded as “short-circuit for restart”.

Thereby, the two short-circuit states and the two open states are completed in sequence, and the restart condition is established. If this condition is not established, the engine is not restarted. In this case, “open” means the state in which the state at 9 V or more continues for 150 ms or more. Accordingly, if short-circuit occurs twice or more at the time interval shorter than this, it is not considered that the restart condition is established.

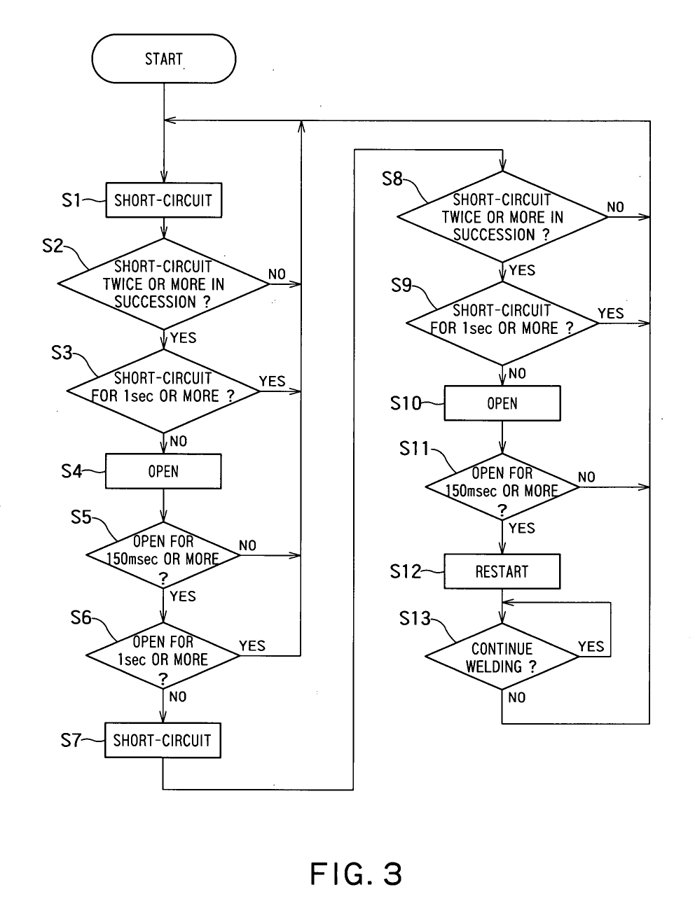

FIG. 3 is a flowchart showing the detecting operation of the restart circuit RS in FIG. 1. It is assumed that while the engine stops, the welding rod WH contacts the base material BM, the voltage between the output terminals + and − reduces to less than 9 V, and this continues for 100 μs or more. This is “simply a short-circuit” state (step S1).

It is determined when the second “simply a short-circuit” state following this “simply a short-circuit” state occurs or whether it occurs or not (step S2), and if it occurs, the flow goes to step S3. If it does not occur twice in succession, or it does not occur at a predetermined time, the flow returns to step S1. In step S3, in order to determine whether the short-circuit state accidentally occurs or not, it is determined whether or not the duration is not less than one second. If it continues for one second or more, it is regarded as an accidental short-circuit state, and the flow returns to step S1.

If it is less than one second, the “open” state in step S4 is established. Therefore, the flow goes to step S5, and it is determined whether or not the duration of the open state is not less than 150 ms. After confirming that this is not an accidental open state, the flow goes to step S6. When the duration time is less than 150 ms, and it is regarded as an accidental open state, the flow returns to step S1.

Next, determination to eliminate the case where the open state is too long and is one second or more is made in step S6, and if it is less than one second, the flow goes through the second short-circuit in step S7, and it is determined whether or not two successive short-circuits for less than 100 μs, specifically, it is determined whether or not it is the short-circuit for restart by the operation of the operator in step S8.

Subsequently, it is determined whether or not the short-circuit continues for not less than one second as in step S3 (step S9). The flow goes through the open state in step S10 and goes to step S11, and it is determined whether or not the open time is not less than 150 ms.

Thereby, the voltage change corresponding to the two short-circuits for restart, that is, the operation of the operator of “tap, tap” is caught, and it is found that this is the situation for restart.

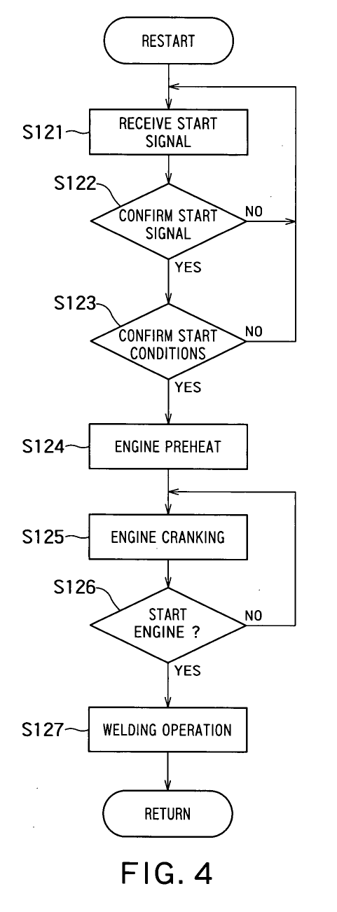

Thus, the restart by step S12 (described in detail based on FIG. 4) is performed. After the restart, the operation is continued as long as the welding operation continues (step S13), and after welding is finished, the welding machine is in the standby state until the next short-circuit occurs by step S1.

FIG. 4 is a flowchart showing the step S12 for restart in FIG. 3 in more detail. Specifically, when the signal for restart is given (step S121), it is confirmed that this is a starting signal (step S122). If it cannot be confirmed, the flow goes to step S121. If it can be confirmed, the flow goes to step S123, and the start conditions are confirmed. The start conditions are whether the circuit breaker for the alternating-current power supply is off, whether the side door is closed and the like.

After the start conditions are confirmed, the flow goes through the preheat of the engine (step S124), and engine cranking (step S125) is performed, and start by steps S125 and S126 is performed until the engine starts. When the engine starts, the welding operation (step S127) is performed, and the flow returns to the main flow shown in FIG. 3.

### Other Embodiments

In the above described embodiment, as the sign set in advance, the predetermined change of the DC voltage is used, but this sign may be the change in current since any sign can be used as long as it can be electrically detected. If the signal which can be reliably discriminated from the noise and the accidental short-circuit is formed, various detecting forms can be selected with respect to the number of short-circuits, time and the like.

What is claimed is:

1. An engine driven welding machine in which a welding generator is driven by an engine, and said engine performs an idle operation when a welding operation is stopped, comprising:
an engine stop signal forming circuit which forms a stop signal for stopping an operation of said engine when time of said idle operation exceeds a predetermined time;
a direct-current power supply connected to an output terminal of said welding machine;
voltage detecting means which detects a voltage change of said output terminal;
a restart detecting circuit which forms a restart signal for restarting said engine when the detected voltage by said voltage detecting means shows a predetermined change mode for starting the welding operation; and
an engine control circuit which stops said engine in response to said stop signal, and restarts said engine in response to said restart signal.

2. The engine driven welding machine according to claim 1,
wherein said direct-current power supply forms predetermined voltage output.

3. The engine driven welding machine according to claim 1,
wherein said restart detecting circuit forms said restart signal when said detected voltage shows the change mode corresponding to repetition of short-circuit and open of said output terminals a predetermined times.

4. The engine driven welding machine according to claim 3,
wherein said restart detecting circuit forms said restart signal when durations of short-circuit and open of said output terminals and intervals of both of them are in predetermined ranges.

5. The engine driven welding machine according to claim 1, further comprising a circuit breaker and an alternating-current output terminal for supplying an alternating-current power supply,
wherein when said breaker is closed, said restart signal is not formed.

6. The engine driven-welding machine according to claim 1, further comprising a casing in which said engine driven welding machine is housed,
wherein when said casing is opened, said restart signal is not formed.
